(19) United States
(12) Patent Application Publication
(10) Pub. No.: US 2016/0202055 A1
(43) Pub. Date: Jul. 14, 2016

(54) SYSTEM FOR DETERMINING INSULATION THICKNESS

(71) Applicants: ROCKWOOL INTERNATIONAL A/S, Hedehusene (DK); DEUTSCHE ROCKWOOL MINERALWOLL GMBH & CO. OHG, Gladbeck (DE)

(72) Inventors: Stephan-Ferdinand REICHINGER, Essen (DE); Markus GRAF, Pasching (AT)

(21) Appl. No.: 14/917,051

(22) PCT Filed: Sep. 5, 2014
(86) PCT No.: PCT/EP2014/068942

§ 371 Date: Mar. 7, 2016

(30) Foreign Application Priority Data
Sep. 9, 2013 (EP) 13183584.5

(51) Int. Cl. G01B 21/08

(52) U.S. Cl. CPC G01B 21/085

(57) ABSTRACT

A system for assisting a user in the determination of a thickness of a layer of insulation, the determination being in compliance with design requirements of thermal safety and heat loss for an object to be insulated, comprises: data input means, for receiving from the user, input data representing boundary conditions relating to the insulated object, the data input means comprising predetermined insulation data storage means from which the user can select predetermined insulation data relating to the insulated object, wherein the input data includes an upper temperature value for calculations relating to requirements of thermal safety and a lower value for calculations relating to requirements of heat loss; means for calculating, on the basis of the input data, insulation thickness data to be output to the user; and display means for displaying the calculated insulation thickness data.

The present invention relates to a system for assisting users in the determination of a thickness of a layer of thermal insulation in compliance with design requirements for an object to be insulated.

The problem of providing appropriate insulation for certain objects such as pipes, tanks, vessels or containers etc. is well known. In the past, there have been various attempts to assist users in choosing insulation materials or cladding and calculate appropriate insulation thicknesses. Determining the appropriate material type and dimensions for the insulation of such objects requires the consideration of many factors. In most cases, design requirements pertain to thermal safety and thus the surface temperature of the insulated object must be calculated. To avoid skin burning by touching the surface of the insulated objects, the surface must be below 60 degrees Celsius, preferably below 50 degrees Celsius.

Even if the surface temperature is reduced to 50 degrees Celsius, for example, there may be considerable energy losses at the surface of the insulated object due to the insulated object losing heat to the ambient medium. The heat loss is dependent on a number of factors which include ambient conditions, such as ambient temperature and wind speed, insulation layer(s) and the respective cladding material. Cladding in this context means an outer surface covering, e.g. an aluminium foil already applied to an insulation product or separately applied sheet metal on the outer circumference of the insulation layer.

To evaluate the heat losses, one must determine the change in temperature of a medium which is inside a tank or a vessel (stagnant medium), or a product inside of a pipeline (flowing medium, stagnant medium, freezing medium, etc). Normally the heat loss is determined by considering worst case scenarios for the ambient conditions, for example −20 degrees Celsius temperatures and 2 m/s wind speed during winter. For example, an insulation thickness of 20 mm is needed to fulfil the requirement for achieving 110 degrees Celsius at the end of a pipe line which has an initial temperature of the medium of 140 degrees Celsius. A bigger insulation thickness, however, might be needed to fulfil the requirement for a surface temperature of maximum 55 degrees Celsius in the summer, at, for example, +30 degrees Celsius and 0.0 m/s wind speed.

As such, the existing systems proposed to assist users in determining insulation information have considerable limitations. One problem with the existing systems is that a series of determinations of the insulation thickness must be done by the user to determine the insulation information which fulfils design requirements other than safety requirements. With most existing solutions, this is an iterative, time-consuming process which requires the designer to flip back and forth between trying to satisfy all design requirements. Furthermore, existing systems provide little ability for the users to determine in a clear and concise manner the effect of particular materials or small increases in insulation thickness which might for example, significantly decrease total lifetime costs, which may include the installation costs and the heat loss costs.

The present invention seeks to overcome some of the above problems.

According to the present invention, there is provided a system for assisting a user in the determination of a thickness of a layer of insulation, the determination being in compliance with design requirements of thermal safety and heat loss for an object to be insulated, the system comprising:
data input means, for receiving from the user, input data representing boundary conditions relating to the insulated object,
the data input means comprising predetermined insulation data storage means from which the user can select predetermined insulation data relating to the insulated object, wherein the input data includes an upper temperature value for calculations relating to requirements of thermal safety and a lower value for calculations relating to requirements of heat loss;
means for calculating, on the basis of the input data, insulation thickness data to be output to the user; and
display means for displaying the calculated insulation thickness data.

A layer of insulation in the sense of the present invention is to be understood as the total insulation for an object. It will be appreciated that a layer of insulation may represent the combination of layer elements and/or insulation thickness components, e.g. a pipe section and a wire mat. As such, the thickness of a layer of insulation may represent the sum of different insulation layers (also referred to as elements of the layer of insulation or layer elements), and/or insulation system components. An ‘insulation system’ in this context refers to the total insulation used for an object (such as a pipe), excluding the object itself, but including e.g. support constructions, bearing constructions, cladding material, mat holders or fixings.

By allowing a user to input both lower and upper values for calculations relating to requirements of heat loss and thermal safety, respectively, the present invention enables users to obtain, with a single calculation by the system, insulation information which satisfies all design requirements. This provides a number of technical advantages in terms of ease of use in view of the reduced amount of effort required from the user, and improved energy efficiency and safety, by optimising the insulation information quickly and efficiently.

Thermal safety calculations allow the user to input temperature values, for example a maximum allowed value of the surface of the insulated object and a minimum medium output temperature, although it will be appreciated that other temperature values, relating to the insulation system or ambient medium are envisaged. Heat loss calculations allow the user to input the maximum allowed energy loss. The values for the heat loss calculations may be in the unit W/m² for plane insulation, such as a slab, and/or W/m in case of pipes for example. Advantageously, the unit of W/m is independent of insulation thickness or outer diameter of the object to be insulated.

However, in case of heat loss calculations, other values can be input by the user. These may include, for example, end temperature of the medium after a defined cooling time of stagnant medium, minimum allowed cooling time of stagnant medium after a certain cooling time, end temperature of a medium after a certain length of a pipeline with flowing medium, and the allowed freezing time of a medium. Alternatively, the user may want to know, for example, how thick the insulation layer must be such that a stagnant medium in a vessel at a certain start temperature, e.g. 100 degrees Celsius, cools down after a certain time, e.g. 12 hours, to an end temperature, e.g. 90 degrees Celsius. Another question which may be answered, for example, is how long does it take for a vessel containing a stagnant medium which cools down from 100 degrees Celsius to 90 degree Celsius (it will be appreciated that with increasing insulation thickness the cooling time increases also).

The input data represents boundary conditions for the object to be insulated. The input data may include, for example: insulation material (e.g. pipe section, wired mat, or compression resistant mat etc.), insulation system components (e.g. support constructions, bearing constructions, cladding material, mat holders or fixings), object type (e.g. pipe, vessel, or flat area), object dimension (e.g. diameter of a pipe or vessel, length of pipelines), object orientation (e.g. horizontal or vertical), and ambient wind speed. The input data may further include a medium temperature representing the temperature of a product located below a surface of the object to be insulated. This may be for a stagnant medium for example in a container such as vessel, or a flowing medium flowing through a pipe for example. It will be appreciated that the product does not have to be in contact with the surface of the object and thus the product may be considered to be inside (rather than below a surface) of the object, for example in cases where the object is not entirely full, such as a roof of a half filled tank. The input data may further include economic boundary conditions (e.g. running hours per year, system lifetime, energy cost and savings compared to the same object without insulation, design cost) and/or ecologic boundary conditions (e.g. fuel type, carbon dioxide emission and savings compared to the same object without insulation).

In alternative embodiments, the data input means may be arranged to receive from the user input data comprised in an input data file, for example an XML file. Advantageously, this enables a user to input a list of predetermined input data.

The insulation thickness data to be output to the user may include for example, insulation thickness values, respective temperatures between elements of the layer of insulation (i.e. ‘layers of insulation’ as defined above), surface temperature of the cladding layer of insulation (as applied to the object to be insulated), heat loss through the layer of insulation, a temperature of the medium, e.g. after a certain period of cooling of a stagnant medium located below a surface, a temperature of the medium at the end of a certain length of pipeline of the insulated object and heat loss costs and heat loss savings compared to the same object without insulation. The data to be output to the user may further include economic boundary conditions (e.g. running hours per year, system lifetime, energy cost and savings compared to the same object without insulation, design cost) and/or ecologic boundary conditions (e.g. fuel type, carbon dioxide emission and savings compared to the same object without insulation).

Furthermore the data to be output to the user may include various ecologic data (which may relate to the same information as the ecologic boundary conditions used as input data, e.g. carbon dioxide emission savings) and various economic data, such as design costs. In this way, the user is able to quickly determine approximate insulation costs for different insulation thicknesses, detailed installing costs for the different insulation thicknesses, and costs of energy loss through the insulation system.

The input and/or output data may also include changes in temperature of the medium or in the insulation system. This may be calculated as a function of time, for example the freezing time of stagnant medium in pipes.

The predetermined insulation data may comprise a plurality of predefined insulation thickness data sets, each insulation thickness data set comprising a predetermined insulation material and a predetermined thickness value, amongst other data relating to the insulated object (e.g. support constructions, bearing constructions, influence of air gaps, etc). Calculating the insulation thickness data by the calculating means may comprise identifying at least one predefined insulation thickness data set which has an insulation thickness value in compliance with the boundary conditions. The display means will thus display the identified at least one predefined insulation thickness data set.

Advantageously, providing predefined insulation thickness data sets, which may represent predefined insulation thickness combinations, leads to a very fast way of calculating insulation data, by proposing the best insulation material (or cladding) to the design requirements thought by the user (e.g. pipe sections for pipes, or compression resistant mats for horizontal vessels).

The display means may display the calculated insulation thickness data alongside a graphical representation of the predefined insulation data (i.e. in a graph), and the data input means may comprise means for varying, by the user, the input data, by selecting differing predefined insulation data items displayed in the graphical representation, to thereby vary the insulation thickness data to be output to the user.

By using the graphical representation of predetermined insulation data and interacting with it, the user is able to make selections of input data, for example insulation material or insulation thickness. This interaction may involve, for example, moving data points in the output area (e.g. representing the insulation thickness) with a mouse of similar, directly on the graph. In this way, the user is enabled to appreciate additional benefits resulting from varying the product selection, which they would not have been able to appreciate with any of the prior art systems. Significant cost benefits may be achieved, in some cases, by increasing the insulation thickness, as will be described in more detail below.

The graphical representation advantageously enables users to determine an economic insulation thickness at an average ambient temperature, representing the insulation thickness corresponding to minimum total costs. The economic insulation thickness, as referred to in the art, represents the minimum point of a curve representing the total costs (i.e. the sum of the costs of installation and the costs of energy losses through the insulation system) as a function of insulation thickness. This minimum point represents the economic insulation thickness where the sum of the costs of installation and the costs of energy losses through the insulation system are the lowest in accordance to economic boundary conditions such as the yearly operation hours of the system, the lifetime of the whole system, the energy prices etc.

Specific examples of the invention will now be described in greater detail with reference to the following figures in which:

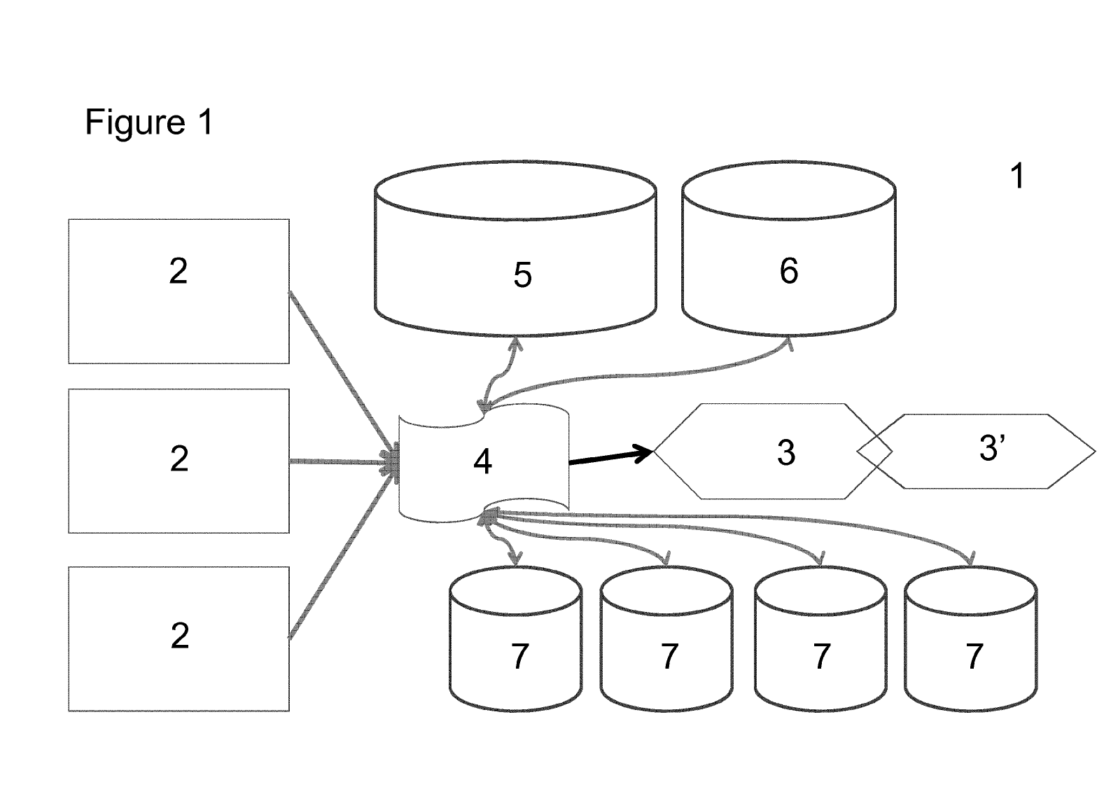

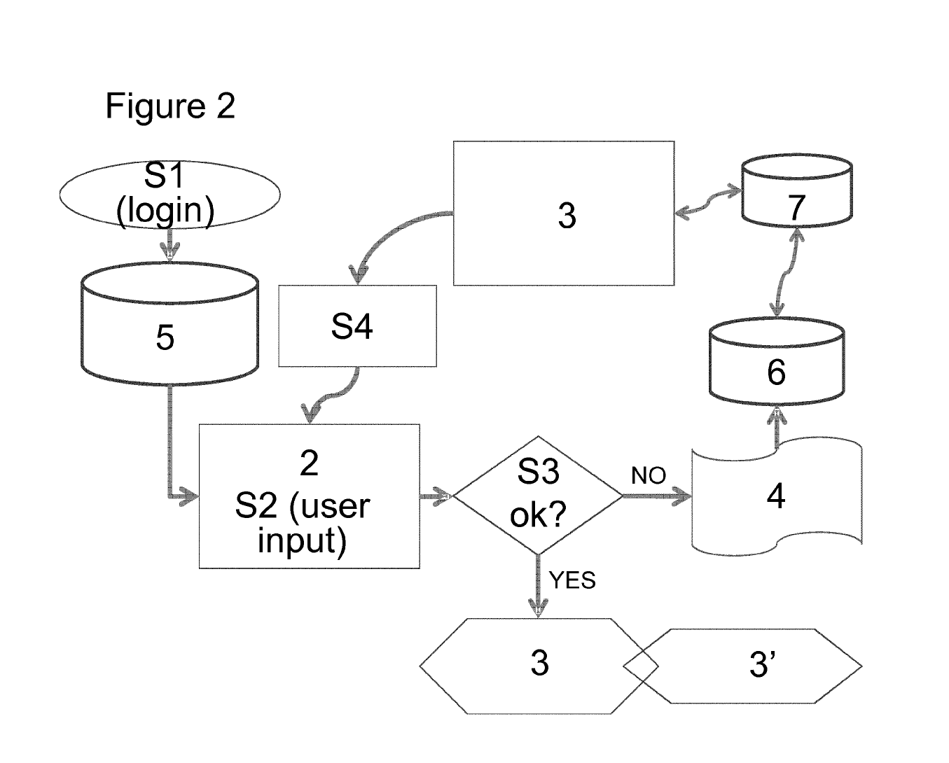

FIG. 1 is a schematic representation showing the underlying operating components of a system in accordance with the present invention;

FIG. 2 is a schematic representation of the manner of operation of a system in accordance with the present invention;

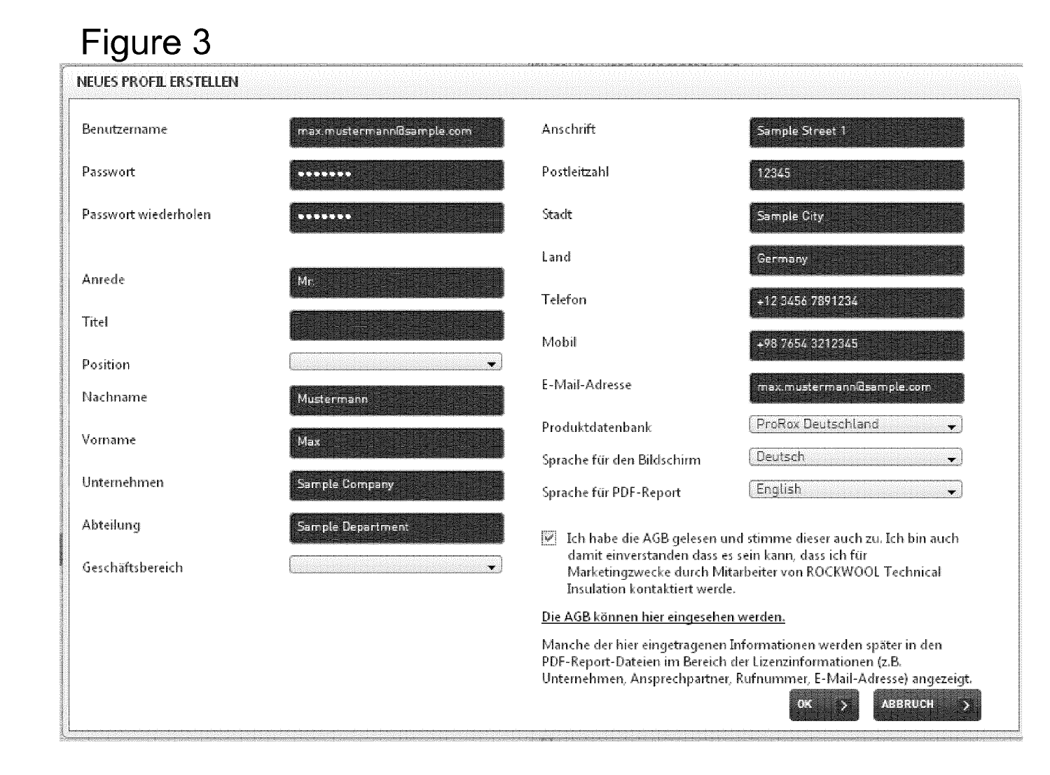

FIG. 3 is an example screenshot showing default settings which may be predefined by a user;

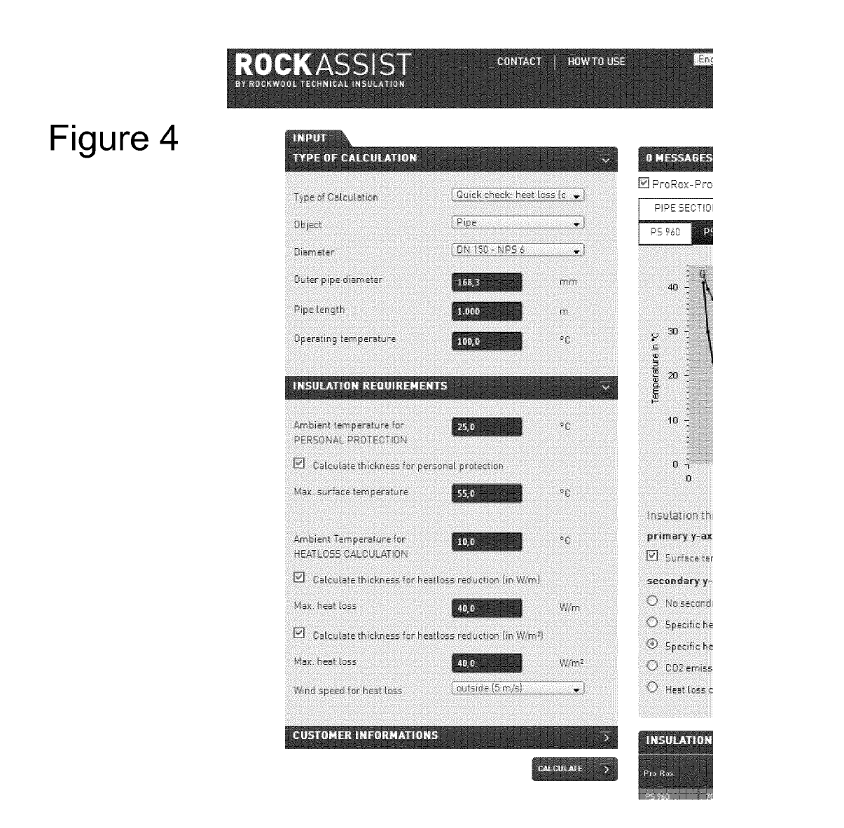

FIG. 4 is an example screenshot showing the input data means in an exemplary ‘Quick Check’ mode;

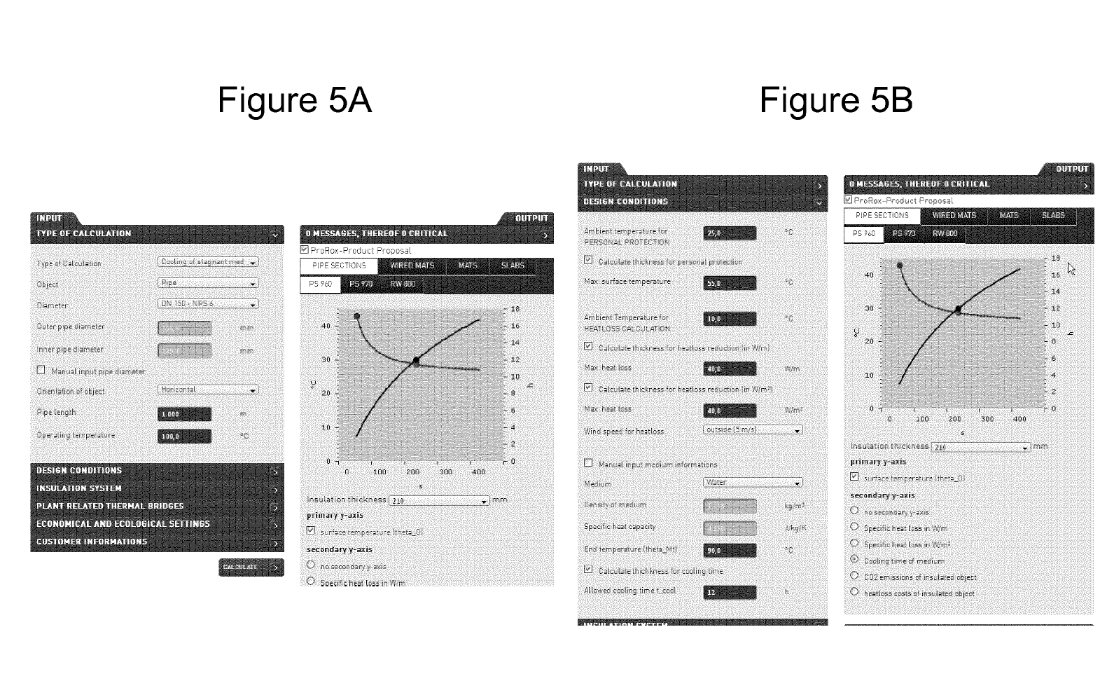

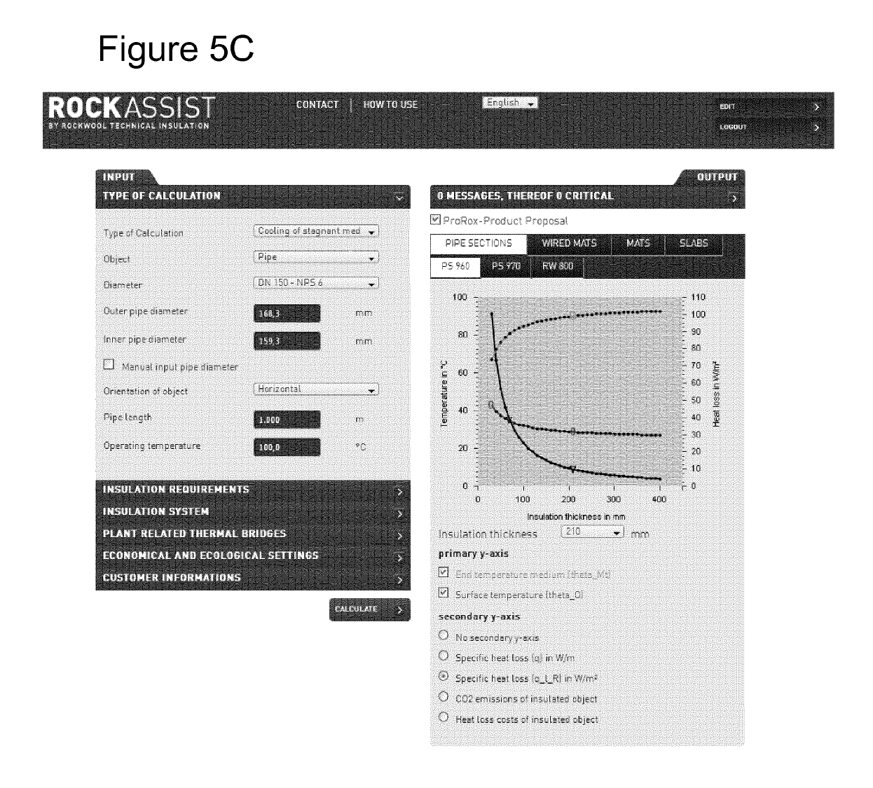

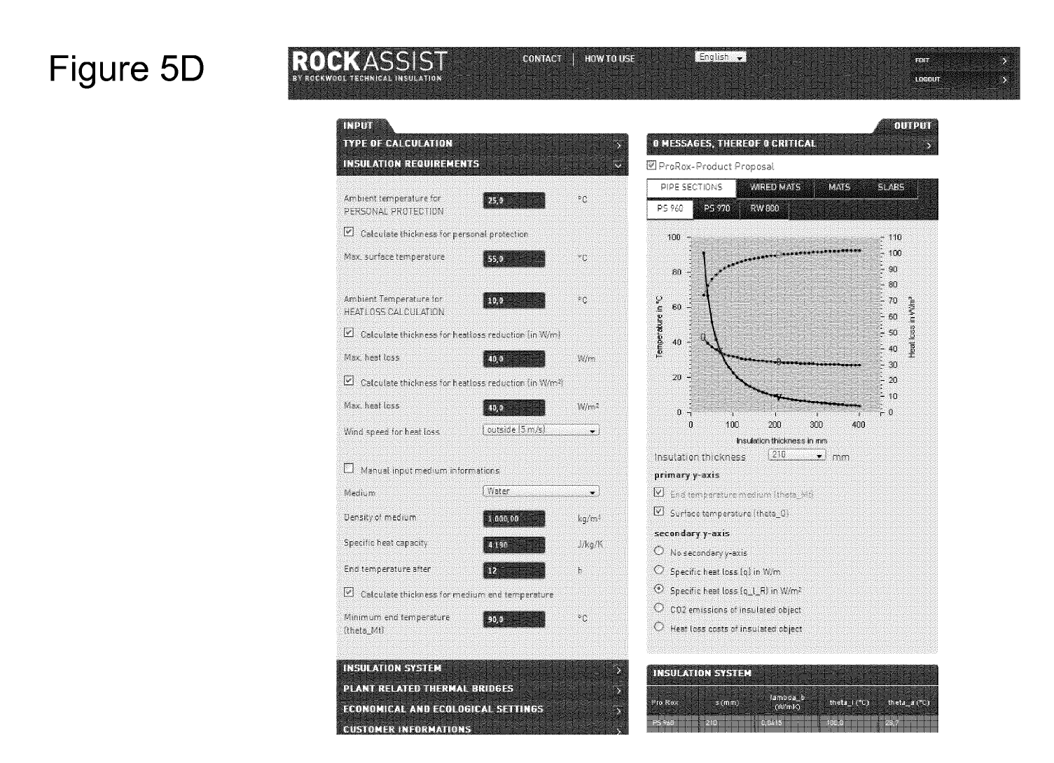

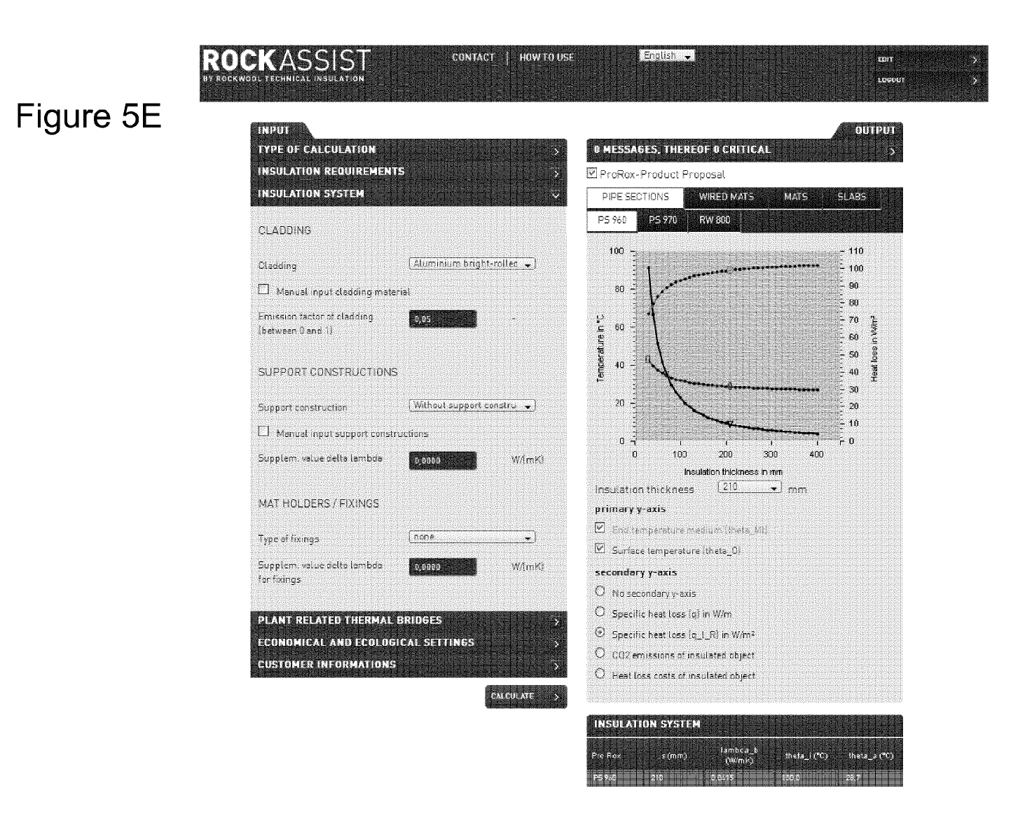

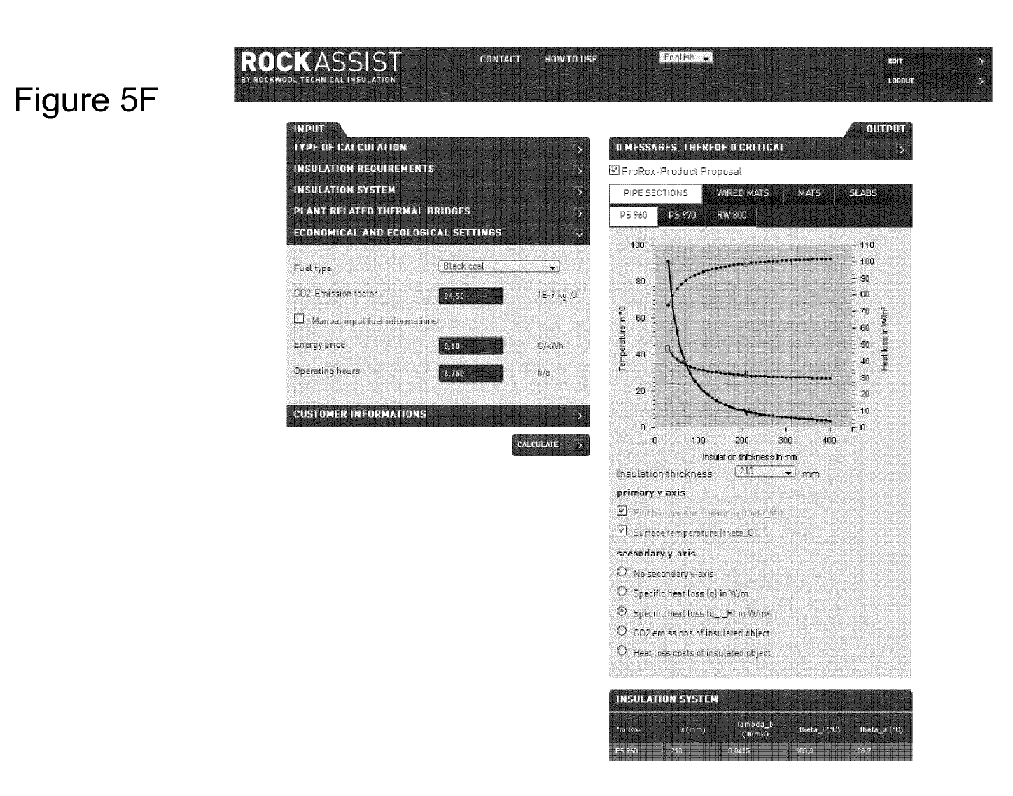

FIGS. 5A and 5B are example screenshots showing the input data for cooling a stagnant medium for a given end temperature and respective display of the output data;

FIGS. 5C to 5F are example screenshots showing the input data for cooling a stagnant medium for a given cooling time and respective display of the output data;

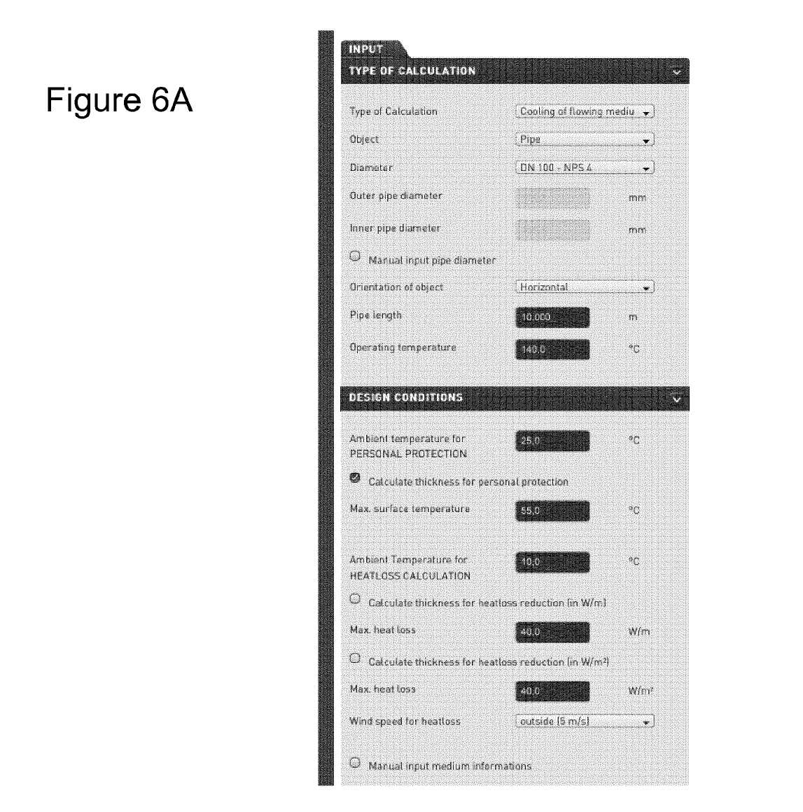

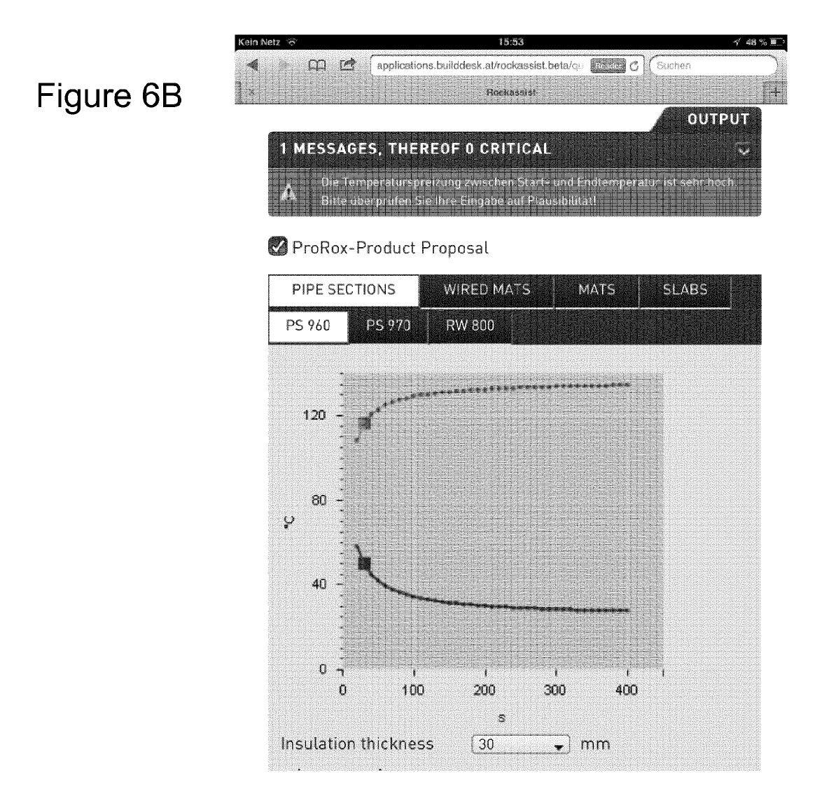

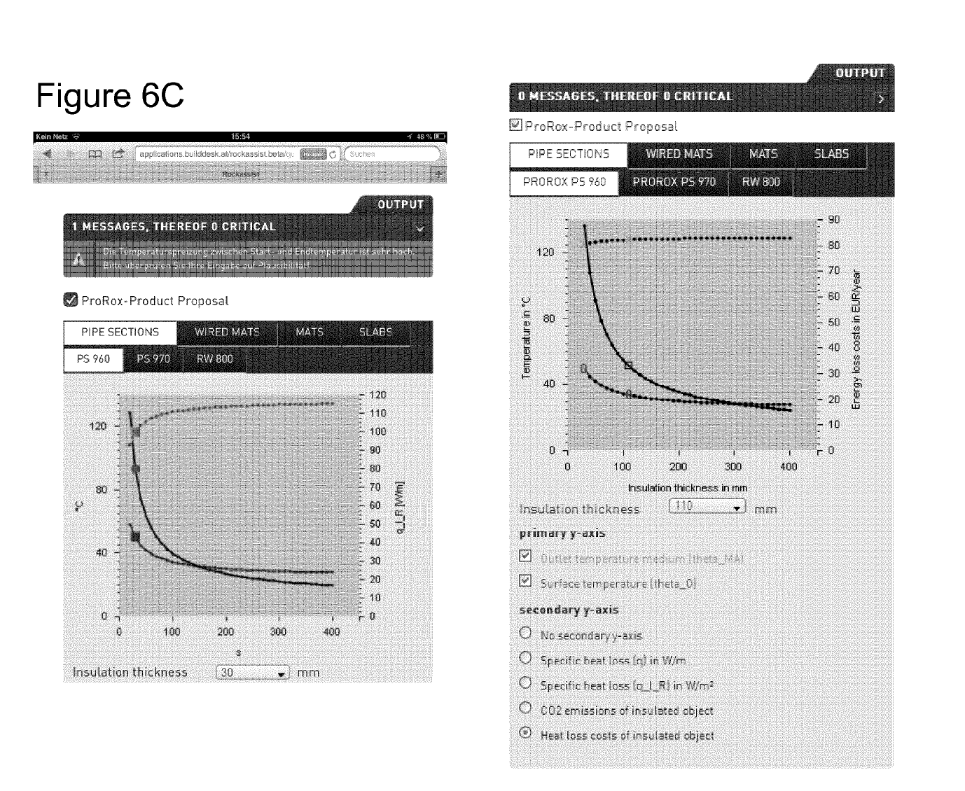

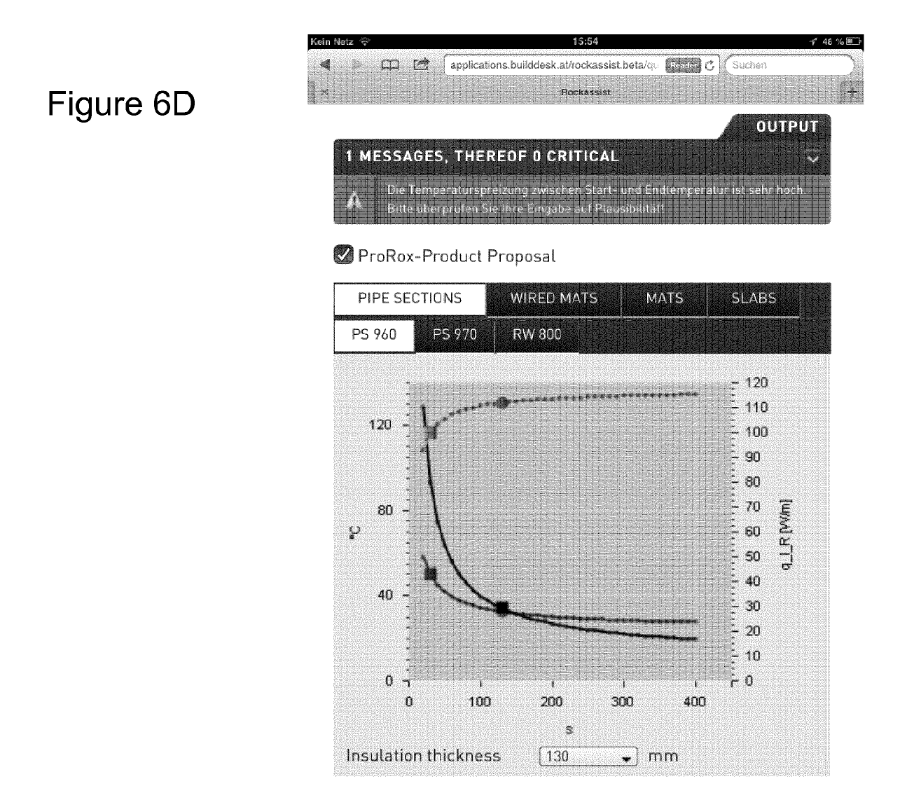

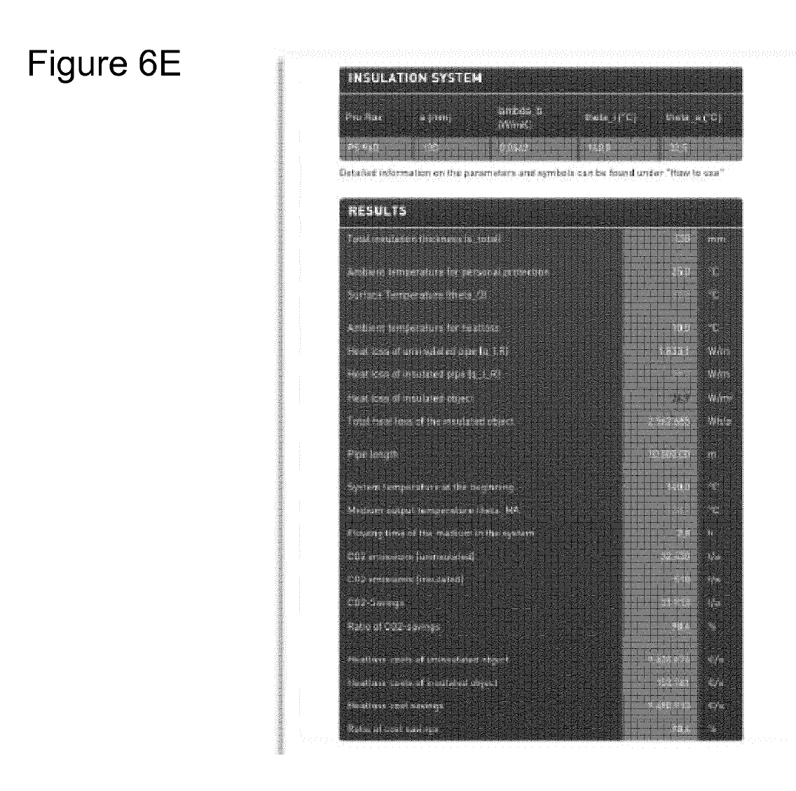

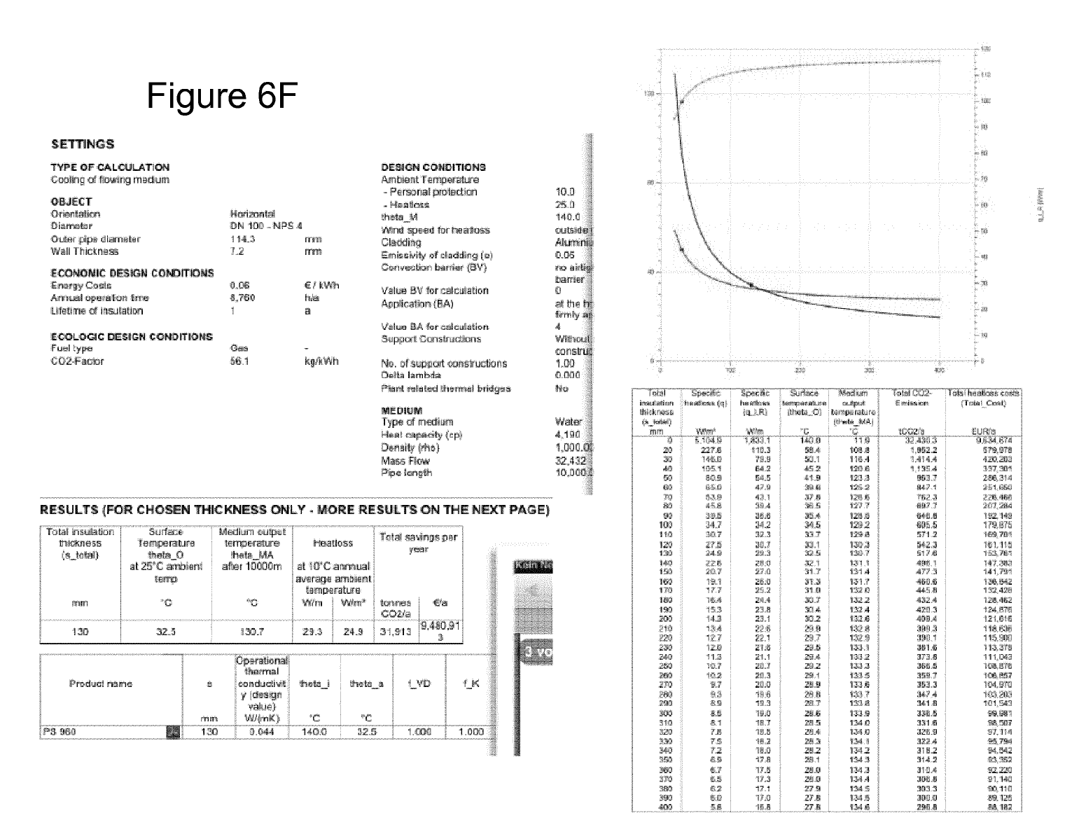

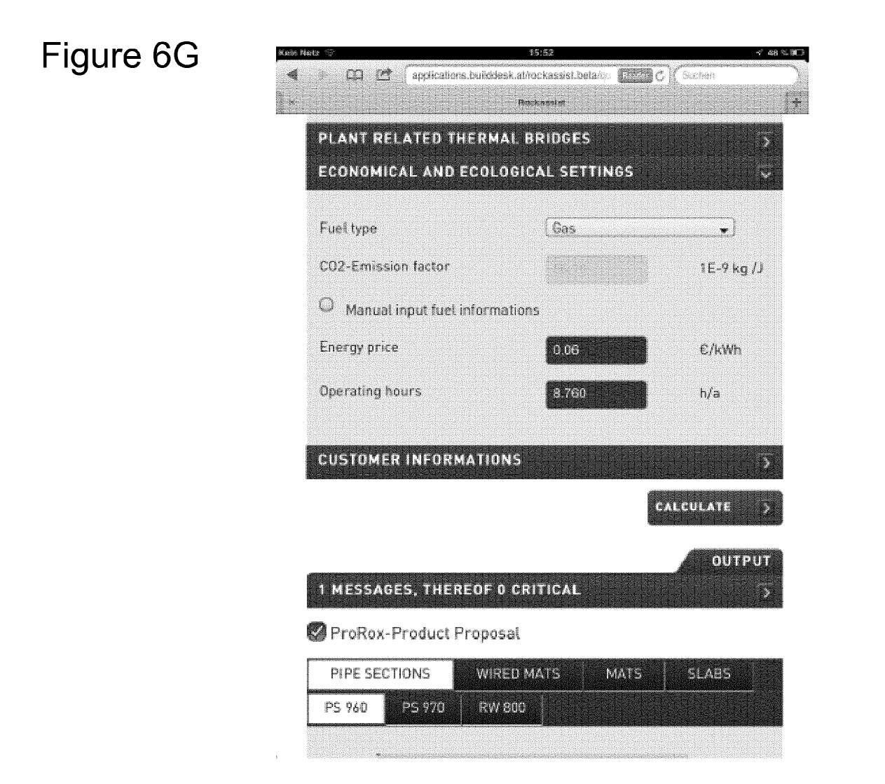

FIGS. 6A to 6G illustrate an example of a calculation made with a system in accordance with the present invention;

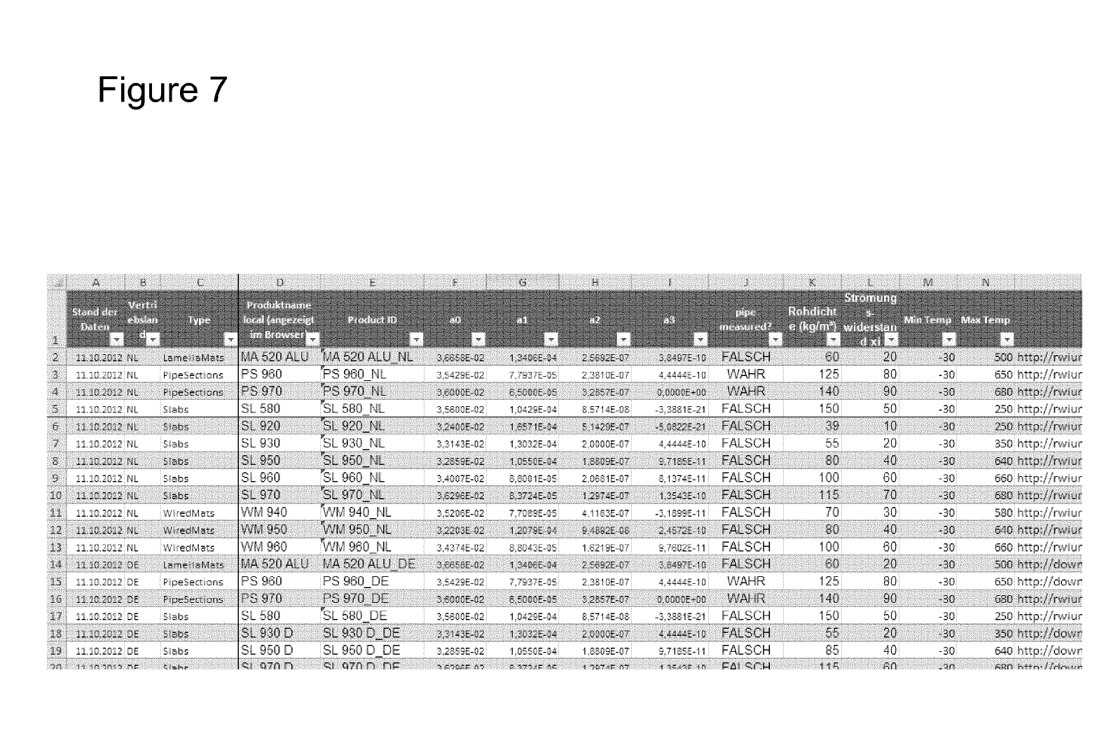

FIG. 7 is an example screenshot of an insulation material (product) database listing insulation materials and their properties;

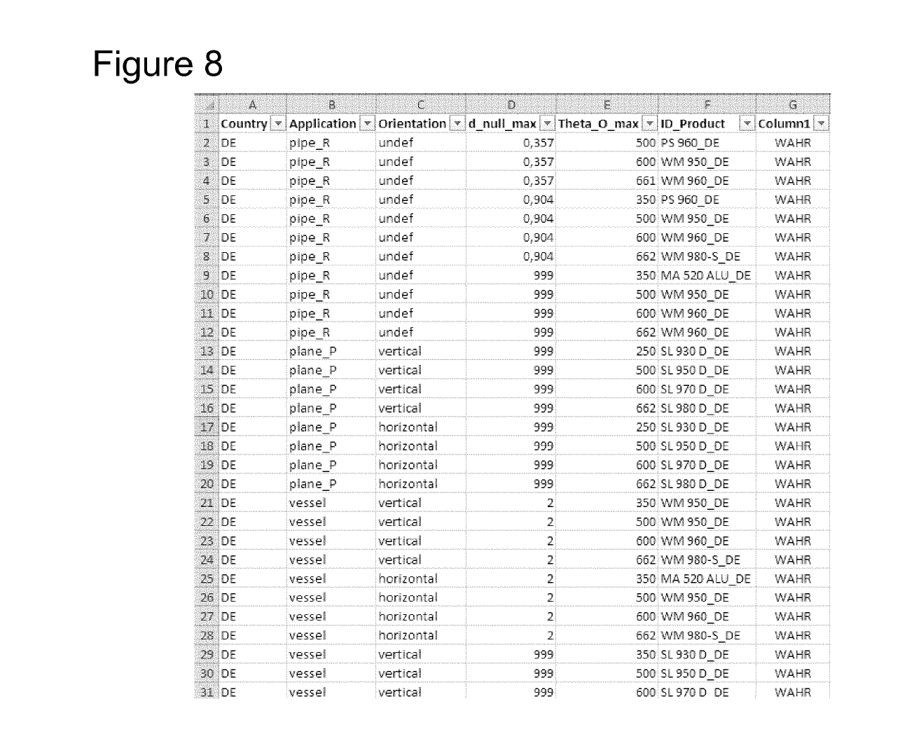

FIG. 8 is an example screenshot of a product proposal database, which enables different insulation materials to be proposed to the user based on the boundary conditions;

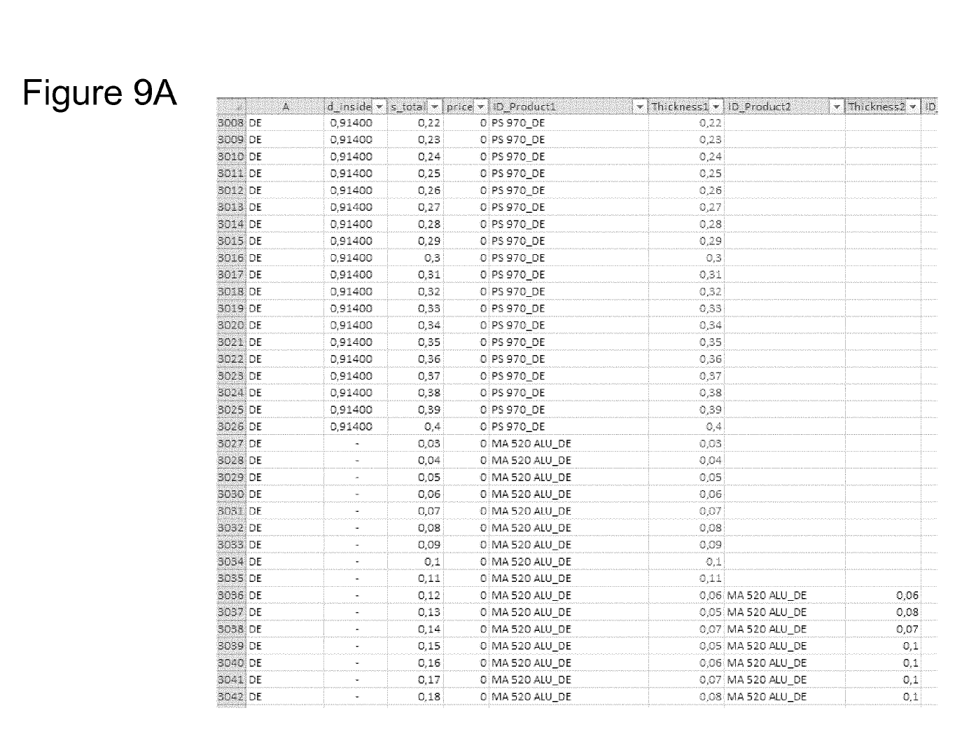

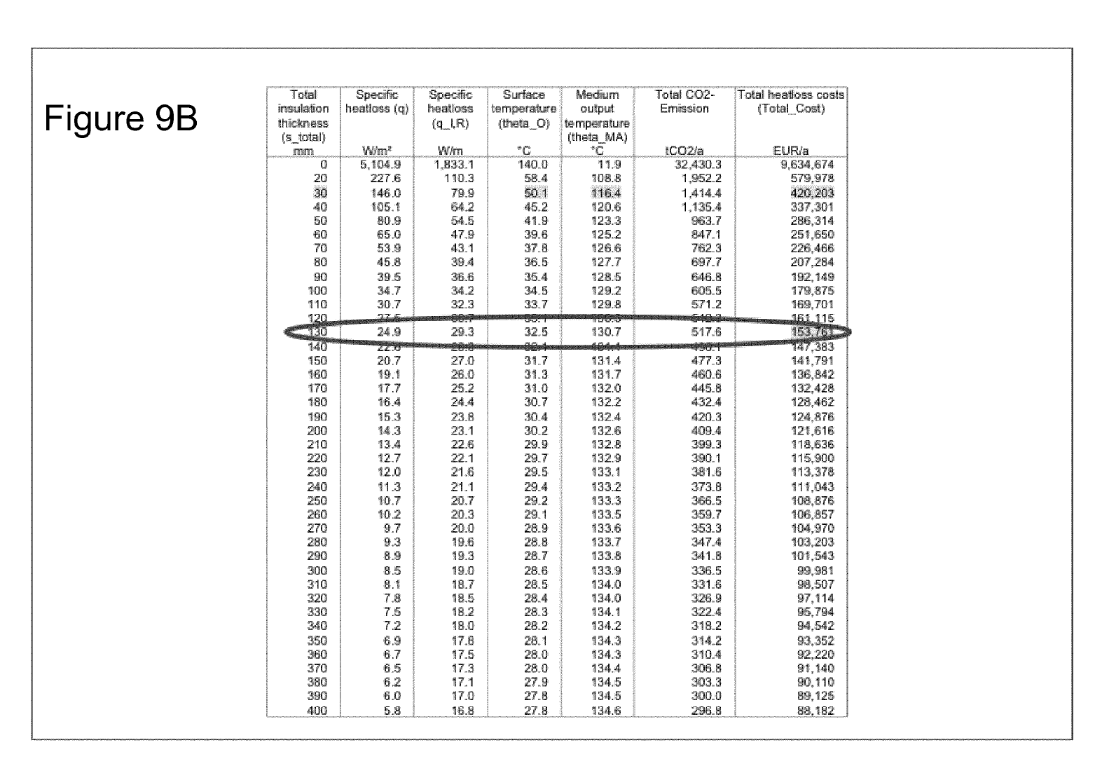

FIG. 9A is a screenshot showing predefined insulation thickness combinations;

FIG. 9B is a list showing exemplary calculation results for predefined insulation thickness values;

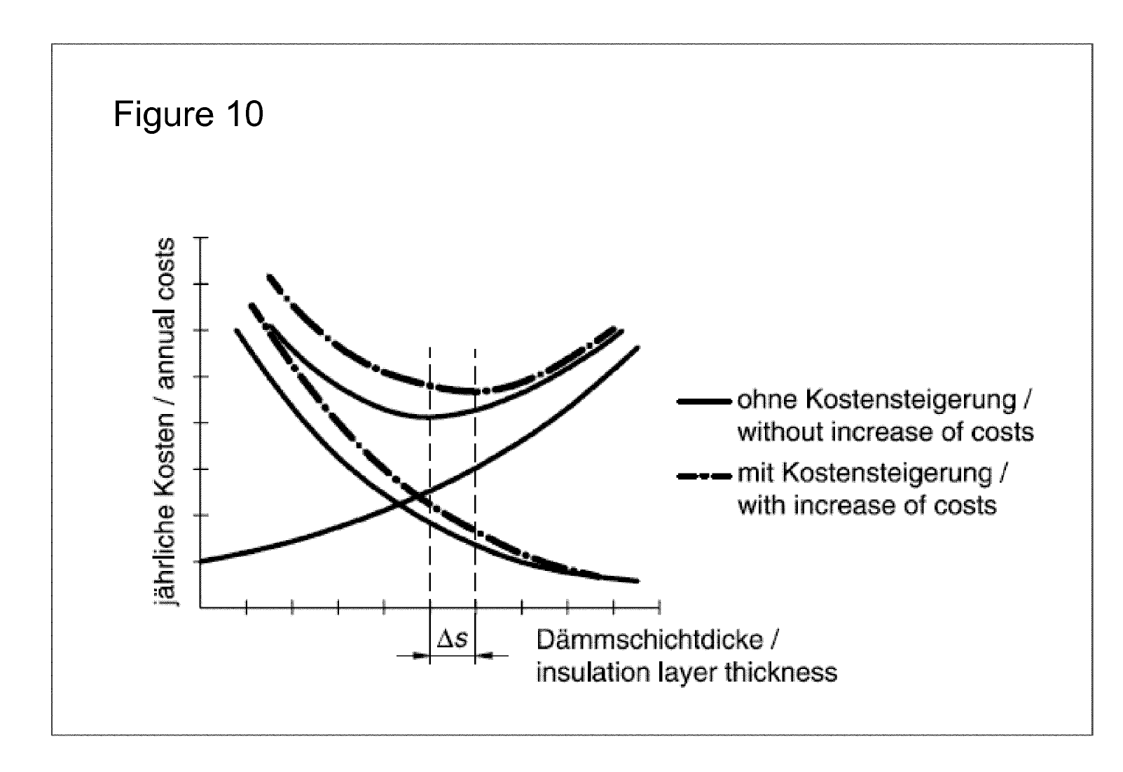

FIG. 10 shows a comparison of the economic insulation thicknesses at constant and at energy rising prices; and

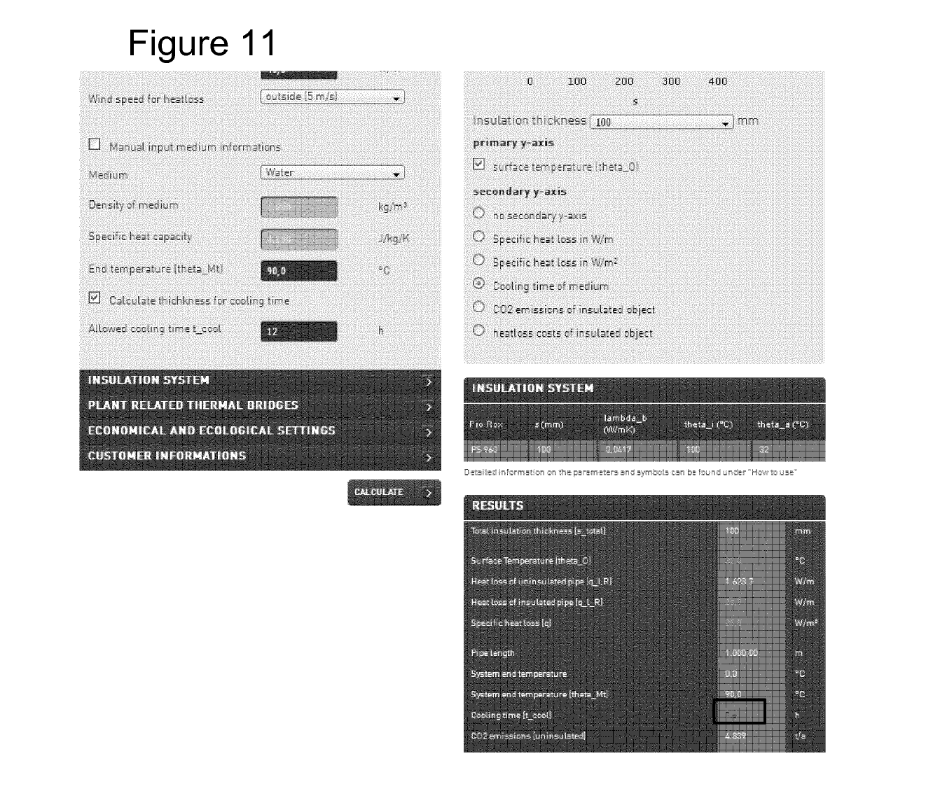

FIG. 11 is a further example screenshot showing input data for cooling a stagnant medium and a display of the output data.

Referring to FIG. 1, a system 1 according to the invention is provided with at least one option for data input means 2 for receipt of data input from a user. The data input means may be a keyboard and/or mouse via which a graphical user interface (GUI) of an internet browser is accessed using a personal computer or network terminal, or a personal device such as a smartphone or tablet for remote GUI access. In alternative embodiments, the input data may be provided in the form of a file, such as an XML file comprising a list of input data values.

A system in accordance with the present invention may be accessed via the internet and may run on a variety of computers and devices, although it will be appreciated that this is not essential to the invention. Preferably, the user is provided with a similar look of the GUI irrespective of the input means. A display 3 provides visual data output to the user in a manner that will be described below. The display may provide the GUI, which may have an input area and an output area for the user to input and interact with the displayed data. Optionally, the visual data to be output to the user may be provided in any format for future reference or storage, such as a PDF document 3′. Advantageously, the user may select the output language (which may be different from the input language) in which the data to be output to the user is presented, for example in the PDF document.

Both the data input means 2 and the display 3 are connected to a processing system 4 also referred to as a means for calculating or calculation engine. The processing system 4 may be an appropriately configured personal computer or network terminal for example. It will be appreciated that certain components of the processor may be provided at one or more remote locations.

The processor comprises a first memory 5 which provides means for storing data input from the user by the data input means 2. The first memory 5 may store various default settings selected by the user, for example input/output language, calculation standard, product database etc. A second memory 6 stores product data such as an insulation material (product) database, which lists various insulation materials and their properties. The second memory 6 may additionally store product proposals based on which different insulation materials may be proposed to a user as will be described in more detail below. There may be further memories (not shown) for storing additional data needed in calculations related to various design requirements which may be sought by the user. It will be appreciated that all of these memories may be provided by a single, larger and appropriately configured memory (not shown).

A processor 7 such as a calculation kernel receives data from the input means and the relevant memories, performs an appropriate calculation as will be described in a detailed manner below, and then outputs calculated insulation thickness data to the display 3. It will be appreciated that one or more calculation kernel standards may be used, including for example British standard BS EN ISO 12241:2008, EN ISO 12241:2008, VDI 2055 (Verein Deutscher Ingenieure, Version September 2008) or ASTM C 680-10.

Referring now to FIG. 2, a system in accordance with the present invention produces a login user interface, at step S1. This login user interface may be in a well know format, although it will be appreciated that this is not essential to the invention. At the login user interface, a user may log into the system in a conventional manner, using for example a unique identification and password. The system produces a display wherein the user is able to input default system settings to be stored in the first memory 5. An example of such a display is shown in FIG. 3. The default system settings may include, for example, GUI language, PDF report output language, product database (e.g. for a country specific market, export market etc.), calculation kernel standard e.g. British standard BS EN ISO 12241:2008, EN ISO 12241:2008, VDI 2055 (Verein Deutscher Ingenieure, Version September 2008) or ASTM C 680-10.

The next step is the input of boundary conditions by the user (at step S2), after the default settings have been input. The system produces a display as exemplified in e.g. FIG. 4, FIGS. 5A and 5B. FIG. 4 shows the input display for a default calculation standard, in this case a ‘Quick Check’ calculation method, or ‘Quick Check’ mode, where most boundary conditions required by the calculations are predefined to obtain safest results. For example, the surface of the insulation system is predefined including an aluminium cladding as it causes highest surface temperatures; the ambient temperature during the summer, when the highest ambient temperatures are expected, is predefined as 25 degrees Celsius; the ambient temperature to be used in calculations of heat loss is predefined as 10 degrees Celsius, which represents the average ambient temperature for the whole year, the maximum allowable surface temperature (which is the upper temperature value for heat loss calculations) is predefined as 55 degrees Celsius. The orientation of the pipe is predefined as horizontal because horizontal pipes cause higher surface temperatures than vertical pipes (due to convection of the surrounding air which cools the surface vertical pipes faster than in the case of horizontal pipes).

In this example, the user is thus only required to fill in the pipe dimensions (e.g. outer pipe diameter and pipe length) and the medium temperature (representing the operating temperature of a flowing medium through the pipe in this case), with all other parameters being set by the system as default. Advantageously therefore, the selection of the insulation material is not required at the start of the calculation. This is particularly useful for users who do not necessarily know the names and properties of the relevant insulation products.

FIGS. 6A to 6G illustrate a further example of a calculation made with a system in accordance with the present invention. With reference to FIG. 6A showing an input display, in a pipe of Diameter Nominal DN 100 (114.3 mm) is a 140 degrees Celsius hot medium, such as water (which may be used in district heating for example). A user allows a cooling of the medium, when it reaches the end of the pipeline, down to 110 degrees Celsius at 10 degrees Celsius ambient temperature. Personal protection boundary conditions are to be fulfilled in that the surface temperature of the insulation system is chosen to be lower than 55 degrees Celsius. The total length of the pipe in this case is approximated to 10 km. FIG. 6B shows the calculation results in an output display. The results displayed in the output display shows the needed insulation thickness to fulfil the end temperature of the medium (at the end of the pipe) and to fulfil the requirement for personal protection.

With reference to FIG. 6C, left screenshot, there are two vertical, or y axes, representing temperature and energy losses respectively. A user may enable the right-hand y axis to show the costs associated with the energy loss of the insulated pipe (FIG. 6C, right screenshot). In this example, a significant energy saving potential is visible due to the steep curve (solid line) representing the energy loss as a function of insulation thickness. In this example, it is easy to see from the graphical representation that the heat loss may be reduced e.g. down to 30 W/m (as indicated by the right-hand y axis).

With reference to the example shown in FIG. 6D, the user may click directly onto the graph, for example to move the points and thereby change the insulation thickness. Alternatively, the user may define a boundary condition in the input area for example to allow a maximum heat loss of 30 W/m. FIG. 6E shows the results of the calculation in this example, summarised in a list in the output display area. FIG. 6F shows an exemplary PDF document which a user obtains by selecting a report button (not shown) which may be located in the output display area. Alternatively or additionally, a user may obtain a graphical representation of the energy loss costs by adjusting energy parameters in the input display area, as illustrated in FIG. 6G.

FIG. 7 is a screenshot of an insulation material (product) database stored in the second memory 6. This database comprising a list of various insulation material (e.g. pipe section, lamella mats, slabs etc.), and their properties including for example name, identification number, dimensions, density, minimum and maximum temperatures which they can sustain, country representing the product standard, date of the product entry in the database, hyperlink to the actual product datasheet, etc.

By choosing a different calculation method, such as the ‘Advanced’ mode, the user is enabled to input further parameters required in the calculations, e.g. support constructions, different cladding materials, fixings, bearing constructions, air gaps inside of the system, etc. The user may optionally input economic boundary conditions such as running hours per year, system lifetime, energy cost and savings compared to the same object without insulation, design cost) and/or ecologic boundary conditions such as fuel type, carbon dioxide emission and savings compared to the same object without insulations.

At step S3, the processing system 4 checks whether the input boundary conditions are complete. It will be appreciated that a ‘complete’ set of boundary conditions includes all parameters required in calculations of thermal safety and heat loss using physical (and, optionally, economic and/or ecologic) principles known in the art. Several examples of such calculations are exemplified in the calculations described herewith.

Default boundary conditions are provided by the system such that the set of boundary conditions required in the calculations is complete. As such, when an input is received from the user, who for example enters a RETURN button after inputting a boundary condition value, the set of boundary conditions contains latest input information. If the set of boundary conditions is incomplete, an error message may be output to the user. If the set of boundary conditions is complete, the processing system 4 performs the calculations and the results are displayed in the display 3. The processing system 4 may also re-calculate the insulation information if for example a different value is chosen by the user in a drop-down input field, or if a CALCULATE button is clicked by the user (who may want to ensure that the calculation is using the latest entries from the user).

In FIGS. 5A and 5B the input and output displays for a calculation relating to the cooling of a stagnant medium for a given temperature are shown on the left hand side and right hand side, respectively. In this example, the user may input start and end temperatures of the medium. For example, the start temperature may be chosen to be 100° C. and an end temperature of 90° C. has to be fulfilled. In other words, in this example the user wants to answer the question, “with increasing insulation thickness, how long does it take for the medium to cool down to 90° C.?”

In the examples shown in FIGS. 5A and 5B, the insulation thickness is represented on the horizontal axis, while the surface temperature is represented on the primary (left hand) vertical, or primary y, axis. Alternatively or additionally to the surface temperature, other boundary conditions such as the specific heat loss, cooling time of medium, carbon dioxide emissions of the insulated object, or costs associated with heat loss and/or installation of the insulated object may be represented on the secondary (right hand) vertical axis, or secondary y axis.

FIGS. 5C to 5F show the input data for cooling a stagnant medium for a given cooling time and respective display of the output data For example, the start temperature may be chosen to be 100° C. and the cooling time is exactly 12 hours. In other words, in this example the user wants to answer the question, “with increasing insulation thickness: which temperature does the medium reach after 12 hours?”

The surface temperature of the insulated object must be calculated under the assumption of a high ambient temperature, representing the upper value to be used in calculations for thermal safety. If this upper value is not entered, as detected in step S3, an error message may be presented to the user in the output display area. Heat loss calculations use a low ambient temperature value, representing the lower value to be used in calculations for heat loss. If this lower value is not entered, as detected in step S3, an error message may be presented to the user in the output area. In addition to error messages, which highlight critical errors in the calculations, hints and information messages, for less than critical or non-critical errors, may also be displayed to enable users to improve the calculations.

By pressing, for example, the RETURN key on the keyboard or choosing another value in a drop-down field or choosing another insulation material or clicking on the CALCULATE button, the software may calculate, if all necessary values are given, the needed thickness of the insulation system for the chosen product. Preferably, the user has the option to select, e.g. using a check-box, if the system is to propose an insulation material. By default, the check-box may be set as active. Only if the check-box is not activated, the user has the possibility to input another product.

The different insulation materials are proposed using a product proposal database which is stored in the second memory 6. A screenshot of a product proposal database is shown as an example in FIG. 8. The product proposal database may store, various data including object type (e.g. pipe, vessel, flat area etc.), orientation of the object (horizontal, vertical), product dimensions (e.g. diameter of pipe or vessel), maximum service temperature (representing the maximum temperature at which the insulation material has been tested). The product proposal database may also store the maximum temperature which represents the best “performance” temperature of the produce. For example, a 100 kg/m³ wired mat has a best thermal performance at temperatures above 300° C., while a 80 kg/m³ wired mat might have a best thermal performance at temperatures below 300° C., even if the maximum service temperature of both products is above 640° C. It will be appreciated that the stored data represents a complete set of boundary conditions in accordance with the algorithms used in the calculations, although further boundary conditions may be used in more sophisticated calculations. For example, the proposed insulation material (product) for pipes with a diameter of 273 mm, having a medium flowing through the pipe of 270 degrees Celsius, is a PS 960_DE pipe section. This product is proposed since it is the best solution for the present boundary conditions.

Based on the insulation material database and the product proposal, the system provides predetermined insulation thickness combinations which are appropriate for a particular insulation material, based on the boundary conditions. A screenshot of example insulation thickness combinations is show in FIG. 8. In the case of a pipe section, for example, results may be determined only if the inner diameter of a pipe section is available for the chosen object diameter. If other insulation materials are chosen, appropriate insulation thickness combinations are proposed.

In the example shown in FIG. 9A, the results are calculated for thicknesses from 30 mm up to 400 mm, at intervals of 10 mm (i.e. in 10 mm steps) although it will be appreciated that these values are not essential to the invention. FIG. 9B is a list showing exemplary calculation results for predefined insulation thickness values. As indicated on this Figure, 30 mm fulfils the personal protection boundary condition for an output temperature of the medium above 110 degrees Celsius. In this example, increasing the insulation thickness up to 130 mm may save more than 266000 Euro each year (420203-153761 Euro), taking into account the full length of the pipeline, which is also part of the input data by the user. The payback time for a 30 mm insulation thickness might be below 4 months, while the payback time for the 130 mm insulation thickness might be below 24 months. In both cases it might be possible that the whole system has a lifetime of more than 15 years.

If a user wants to make calculations using very high temperatures of the medium, a combination of proposed products is possible, using for example special high temperature wired mats in a first insulation layer element and “normal” wired mats in additional insulation layers elements, wherein the total insulation layer is made up of all the insulation layer elements for example. If the user wants to reduce heat losses by support constructions, a combination of pipe sections in the first layers elements and a load bearing mat in the last layer element would be able to be proposed by the system. It is also possible to calculate, for example with series from 25 up to 425 mm, a total insulation thickness which represents a combination of e.g. 25 mm ceramic wool and wired mats wherein only the thickness of the wired mats is increasing.

Based on the boundary conditions input by the user (at step S2) and the insulation material chosen by the system from the product proposal database (stored in the second memory 6), calculations are performed by the processing system 4 for the predefined insulation thickness list. In this example, the predefined insulation thickness ranges from 20 or 30 mm up to approximately 400 mm, in 10 mm steps. The first insulation thickness value which fulfils all boundary conditions is selected by the processing system 4 to be output to the user in the display 3.

Advantageously, calculations for heat loss (with a lower ambient temperature and average wind speed for example) as well as thermal safety (with a high ambient temperature and zero wind speed for example) are performed by the system simultaneously. As such, one click from the user in the input area may lead to multiple calculations in the calculation kernels. It will be appreciated that ambient wind at the ambient temperature cools down the surface temperature of an insulation system. As such, the default boundary condition for wind speed in calculations of thermal safety may be set to zero, although, in alternative embodiments, this value may be input by the user as included in the input data.

In case of pipes or vessels, users are able to define boundary conditions for heat loss in both units of W/m² surface area and also/or in W/m (Watts per metre of pipe length or per metre of vessel length). If a pipe has a small diameter and a big insulation thickness with a poor thermal performance (represented by lambda value) of the insulation material, increasing the outer diameter would directly decrease the heat loss in W/m² due to the bigger surface area. Representing the heat loss in W/m is advantageous because this value is independent of the insulation thickness or outer diameter of the object to be insulated.

The calculated insulation thickness which fulfils all boundary conditions may be output to the user in a graphical representation or diagram. For example, the calculated insulation thickness may be represented as a point on a curve which represents the predetermined insulation thickness values as a function of the parameters used in the boundary conditions, such as surface temperature.

By representing the total costs (i.e. the sum of the costs of installation and the costs of energy losses through the insulation system) as a function of insulation thickness, the economic insulation thickness may be readily determined by the user. The economic insulation thickness represents the minimum point of this function, in accordance to economic boundary conditions such as the yearly operation hours of the system, the lifetime of the whole system, the energy prices, installing costs, etc. FIG. 10 shows a comparison of the economic insulation thicknesses at constant (solid curve) and at energy rising prices (dotted curve), as included in the standard document VDI2055. The total costs are represented on the vertical axis and the insulation thickness is represented on the horizontal axis. Since the function of total costs is very flat in the vicinity of the minimum and may contain steps, the result is very sensitive to an exact calculation.

For example, the total costs for plane insulation may be calculated using the following equation:

K_{ges}=3,6·10⁻⁶·q·f·W·β+b·J_{P} in [symbol] /(m²·a)

while the total costs for a pipe insulation layer may be calculated with the following equation:

K_{L,ges}=3,6·10⁻⁶·q_{1,R}·f·W·β+b·J_{1,R} in [symbol] /(m·a)

where the economic insulation thickness represents the minimum of the total costs for plane insulation, K_{ges}, and for pipe insulation, K_{L,ges}, respectively, J_{P} represents investment costs for plane insulation (e.g. in Euro/m²), J_{I, R} represents investment costs for pipe insulation (e.g. in Euro/m), q represents the heat loss of a plane insulation (in W/m²), q represents the heat loss of a pipe (in W/m), W is the actual heat cost (e.g. in Euro/GJ), β is the annual operation time (in h/a), b is the capital service factor (in I/a), and f is the factor for price change to take energy price changes into account.

The user may change the insulation thickness directly on the graphical representation (e.g. clicking on different values on the horizontal axis) or by choosing a different value from a drop down menu for example. Advantageously, changing the insulation thickness by the user changes the displayed results without performing a new calculation by the system, since the predefined insulation thickness combination has already been identified by the system in the previous calculation and this provides multiple insulation thicknesses (all shown insulation thicknesses are calculated and stored in the memory). In other words, only the values for the chosen insulation thickness are refreshed in the diagram. If, for example, the user holds the mouse above a dot in the diagram, a “Tooltips” display function may indicate the values of this point (x and y values of the graph).

If, for example, a thinner insulation thickness is chosen by the user, the insulation thickness value which does not fulfil the boundary conditions may be displayed in a red colour in the output area. This is also shown in the case of FIG. 11, where the user has input a thinner insulation thickness value, and the results are displayed in the results area in a different colour (and/or indicated by a textbox) in the displayed Results section. In this example, the results indicate that for an insulation thickness of 100 m (manually chosen by the user from the drop down menu at the top of the output area), the medium would cool down to 90° C. within 7.6 hours, which is less than 12 hours (the allowed cooling time boundary condition selected in the input area).

Referring back to FIGS. 5A and 5B, by deactivating the ‘Product Proposal’ check box in the output section, the user is able to change the insulation material (at step S4 in FIG. 2), e.g. change from a pipe section to wire mats, lamella mats, or slabs (NB using slabs on pipes may cause error messages, e.g. that the usage of slabs on pipes is not recommended or possible). By clicking on another insulation material, the processing system 4 calculates the new calculation results for each thickness combination which is predetermined by the system, as predefined insulation thickness data sets. In this way, the system does not need to recommence the calculation if the user wants to change an insulation product.

1. A system for assisting a user in the determination of a thickness of a layer of insulation, the determination being in compliance with design requirements of thermal safety and heat loss for an object to be insulated, the system comprising:
data input means, for receiving from the user, input data representing boundary conditions relating to the insulated object,
the data input means comprising predetermined insulation data storage means from which the user can select predetermined insulation data relating to the insulated object, wherein the input data includes an upper temperature value for calculations relating to requirements of thermal safety and a lower value for calculations relating to requirements of heat loss;
means for calculating, on the basis of the input data, insulation thickness data to be output to the user; and
display means for displaying the calculated insulation thickness data.

2. A system according to claim 1, wherein the predetermined insulation data storage means stores predetermined system data for the calculations relating to requirements of thermal safety and heat loss, and wherein the predetermined system data is used by the calculating means in the calculation of the insulation thickness data to be output to the user.

3. A system according to claim 2, wherein the predetermined insulation data comprises a plurality of predefined insulation thickness data sets, each insulation thickness data set comprising a predetermined insulation material and a predetermined thickness value,
wherein calculating the insulation thickness data by the calculating means comprises identifying at least one predefined insulation thickness data set which has an insulation thickness value in compliance with the boundary conditions, and wherein the display means displays the identified at least one predefined insulation thickness data set.

4. A system according to claim 3, wherein the display means displays the calculated insulation thickness data alongside a graphical representation of the predefined insulation data, and
wherein the data input means comprises means for varying, by the user, the input data, by selecting differing predefined insulation data items displayed in the graphical representation, to thereby vary the insulation thickness data to be output to the user.

5. A system according to claim 1, wherein the upper value for calculations relating to requirements of the thermal safety is one or more from the group of: a maximum ambient temperature, an average ambient temperature, a maximum medium output temperature, a maximum medium temperature after cooling time for reaching a medium temperature.

6. A system according to claim 1, wherein the lower value for calculations relating to requirements of heat loss is one or more from the group of: a minimum ambient temperature, an average ambient temperature, a minimum medium output temperature, a minimum medium temperature after a cooling time and a cooling time for reaching a medium temperature.

7. A system according to claim 1, wherein the input data further includes one or more from the group of: insulation material, insulation system components, object type, object dimension, object orientation, a medium temperature representing the temperature of a product located below a surface or inside of the object to be insulated, economic boundary conditions, ecologic boundary conditions, changes in medium temperature and ambient wind speed.

8. A system according to claim 1, wherein the insulation thickness data to be output to the user includes one or more from the group of: insulation thickness, surface temperature, heat loss through the layer of insulation, a medium temperature representing the temperature of a product located below a surface or inside of the insulated object, changes in medium temperature, economic data and ecologic data.

9. A system according to claim 1, wherein the layer of insulation comprises at least one insulation layer element, each of the at least one insulation layer element comprising a respective insulation material.

10. A system according to claim 9, wherein the layer of insulation further comprises at least one insulation system component.

11. A system according to claim 9, wherein the insulation thickness data to be output to the user includes a temperature of at least one insulation layer element.

12. A system according to claim 1, wherein the data input means in arranged to receive input data comprised in an input data file.
